(19) United States
(12) Patent Application Publication
(10) Pub. No.: US 2012/0100758 A1
(43) Pub. Date: Apr. 26, 2012

(54) SOCKET CONNECTOR WITH CONTACT TERMINAL HAVING OXIDATION-RETARDING PREPARATION ADJACENT TO SOLDER PORTION PERFECTING SOLDER JOINT

(75) Inventors: BEEN-YANG LIAW, New Taipei (TW); CHIH-PI CHENG, New Taipei (TW); FU-JIN PENG, Shenzhen (CN); ZHAN-JUN XU, Shenzhen (CN)

(73) Assignee: HON HAI PRECISION INDUSTRY CO., LTD., New Taipei (TW)

(21) Appl. No.: 13/033,334

(22) Filed: Feb. 23, 2011

(30) Foreign Application Priority Data
Oct. 23, 2010 (CN) 201010517511.2

(51) Int. Cl. H01R 24/00; H01R 43/16; H01R 4/02

(52) U.S. Cl. 439/660; 439/874; 29/874

(57) ABSTRACT

Provided herewith a socket connector adapted to be mounted on a substrate having a conductive element is provided, and comprises an insulative housing, the housing having an exterior side adapted to face the substrate. A stamped contact is formed from a sheet of conductive material and is adapted to mate with a conductive component and extending substantially to the exterior side of the housing. The contact has a connection portion and wherein a substantially dried preparation of oxidation retarding and solder affinity deployed on the terminal portion before the contact assembled into the connector. The connector further includes a body of reflowable, electrically conductive material associated adjacent to the connection portion adjacent the exterior side of the housing.

### CROSS REFERENCE

The present invention is related to “SOCKET CONNECTOR WITH CONTACT TERMINAL HAVING WAVEFORM ARRANGEMENT ADJACENT TO TAIL PORTION PERFECTING SOLDER JOINT”, application Ser. No. 12/763,226, filed Apr. 20, 2010, and its continued application, application Ser. No. 12/853,317, filed Aug. 10, 2010.

### BACKGROUND OF THE INVENTION

1. Field of the Invention

The present invention relates to a socket connector, and more particularly to a socket connector incorporated with a contact terminal having a layer of solder affinity and oxidation retarding preparation adjacent to a wave arrangement adjacent to a tail portion of the contact terminal so as to perfect solder joint with respect to a conductive pad of a substrate and the tail portion.

2. Description of the Related Art

Soldering between a solder tail of a contact terminal and a conductive pad on a printed circuit board is comparably reliable and commonly practiced in the electrical connector field. When conducting a soldering process, there is a dilemma. At one hand, it is requested that the solder tail expresses solderable property, i.e. the solder can be readily and easily attached thereto. If the solder joint is not properly formed between the solder tail and the printed circuit board, defective interconnection or so called cold-joint will be encounter. Rework process will always be needed to correct this problem. On the other hand, because of this solderable property, the solder tends to flow upward or wick along an external surface of the solder tail. Once the solder flows and wicks upwardly along the surface resulted from the capillary force, the overall characteristic of the contact terminal will be changed or negatively modified. For example, when the contact terminal is designed, intended normal force, deflection, etc have been carefully calculated so as to meet the field requirements. Once the solder flows and wicks upwardly to cover the contact terminal, the characteristic of the contact terminal will be altered, and the normal force and other properties will be altered accordingly. In worse situation, a connector after soldering will be found failed resulted from this solder wicking. As a result, the contact terminal is requested to provide a mechanism to limit the wicking.

U.S. Pat. No. 4,019,803 issued to Schnell on Apr, 26, 1977 disclosed a solder substrate clip having a contact arm. A mass of solder is secured to the arm on a side away from a contact surface and a solder globule integral with the mass of solder at an edge of the arm extending from the mass across the edge of the arm to the contact surface for engagement with a contact pad on the substrate.

U.S. Pat. No. 4,846,734 issued to Lytle on Jul, 11, 1989 discloses a connector featuring that a connector adapted to be attached to a mother printed circuit board and to removably receive a daughter printed circuit board of the edge card type and adapted to mechanically and electrically couple the mother and daughter printed circuit boards. According to its disclosure, the invention may be incorporated into a method to make the contact terminal and which further includes the step of fabricating the contact of phosphor bronze. The method further includes the step of plating the contact with nickel to a thickness of about between 0.000050 and 0.000150 inches. The method further includes the step of plating the lower portion of the contact with solder of about 60 percent tin and 40 percent lead to a thickness of about between 0.000100 and 0.000500 inches. The method further includes the step of plating the contact portion of the contact with about 40 microinches thick or thicker of PdNi flashed with gold to a thickness of about 0.000004 inches nominally. It is known to the skilled in the art that tin-lead is solderable material, while nickel oxide is non-solderable. Because of that, a tin-lead coating is applied to the lower portion, which according to Lytle, it increases solderablility of the lower portion which is intended to be soldered into a via of a printed circuit board.

U.S. Pat. No. 5,453,017 issued to Belopolsky on Sep. 26, 1995 expressivebly take the advantage of the benefit disclosed in Lytle. In Belopolsky, it discloses an improved connector for an electronic module or the like and includes a housing having a socket opening that is sized and configured to accept an electronic module, and a plurality of terminals mounted to the housing. Each of the terminals has a foot portion having a layer of non-solderable material coated on one side of the foot portion to prevent solder from adhering to that side. A capillary nest is formed by a channel surface on the underside of the foot portion when the terminal is mounted on a conductor pad such that solder flows through the capillary nest under the influence of capillary forces from the side of the terminal having a non-solderable coating thereon to the other side for forming a solder joint on that other side. A ring of non-solderable material is coated around a middle portion of the terminal to prevent solder from flowing to the electrical contact surfaces located above the ring. As a result, the connector terminals can be soldered to a printed circuit board or the like in a simple and inexpensive manner and without the formation of known solder defects. As disclosed by Belopolsky, solderable material used in capillary nest is to promote solderability on the solder tail, while the non-solderable ring located at the middle portion limits the solder from wicking further upward.

U.S. Pat. No. 4,722,470 issued to Johary on Feb. 2, 1988 discloses another mechanism to overcome or control the solder wicking. According to Johary, a solder transfer member for applying discrete bodies of solder of predetermined size to the leads of a component for subsequent surface mounting to a substrate. The transfer member is a plate having a non-wetted surface, for example titanium, with an array of cavities matching the component lead pattern, each having a volume corresponding to the desired amount of solder to be applied to the corresponding lead. The method includes placing solder paste on the transfer member and filling the cavities by wiping the plate surface. The component is placed on the transfer member with the leads contacting the solder paste in the cavities. Reflow of the solder paste bonds to each lead a discrete body of solder having a precisely determined size. To limit wicking of solder on the leads, selective masking may be performed by applying a water soluble mask coating to the leads and removing the mask from selected areas by placing the component against a surface charged with water before placing the component on the transfer member.

U.S. Pat. No. 6,042,389 issued to Lemke on Mar. 28, 2000 disclosed another mechanism to limit the solder wicking issue. According to FIG. 6, along with description, “The opening 96 also can function as a thermal break to retard solder wicking, in the same manner as openings 89 in the FIG. 6 embodiment. The terminal 90 may also include passivation or anti-wicking coatings to prevent solder flow toward the contact sections. Aperture or opening 89 defined in the contact tail 76 is used to limit the wicking issue.”

U.S. Pat. No. 4,019,803 issued to Schnell on Apr. 26, 1977 discloses a solder substrate clip having a contact arm, a mass of solder secured to the arm on a side away from a contact surface and a solder globule integral with the mass of solder at an edge of the arm extending from the mass across the edge of the arm to the contact surface for engagement with a contact pad on the substrate. According to its description, along with FIGS. 1 to 4, it looks like that Schnell uses energy to control the wicking issue. According to Schnell, the amount of energy supplied to the interface between the solder mass and the arm is sufficient to melt the entire mass, in that way assuring that a relatively large mass of molten solder does not coat the contact surface of the arm. While molten solder does not readily flow across the raw uncoated edges, a relatively large amount of molten solder could flow across the edges and coat the contact surface. This is undesirable because when a substrate is moved into the mouth the arms are bent further apart than intended due to the thickness of the solder coating and may be overstressed. During soldering of the clip to the substrate, the thick layer of solder would be melted freeing the arms for undesired movement during the soldering operation. Overstressed arms may not be strong enough to engage the substrate tightly.

U.S. Pat. No. 4,120,558 issued to Seidler on Oct. 17, 1978 discloses another way, as compared to Lemke and Schnell, to attach the solder mass to the contact. Seidler uses spring fingers to mechanically hold the solder mass, such as shown in FIGS. 1 to 5, and 13 to 15. According to Seidler, each clip includes a flat body portion 15, a pair of spring fingers 16, bent to extend upwardly and laterally from the plane of the body portion distally of the clip and spaced apart by the width of a central spring finger 17 which extends laterally in a position spaced from and substantially parallel to the fingers 16, defining a gap 21 adapted to receive the edge of a substrate (not shown). The fingers 16 and 17 are formed from the blank shown in FIG. 4 by the parallel cuts 18 which terminate at end points 18′. An additional gripping finger 19 is provided by the U-shaped cut 20, the sides of which lie parallel to the cuts 18 and the closed end 20′ being below the line of the ends 18′, this finger thus being formed partially from the material in the central finger 17. The free end of the finger 17 is curved arcuately away from the finger 16, and the gripping finger 19 is curved arcuately toward the curved end of finger 17, in a position to grip securely the short cylindrical slug of solder 22, as clearly shown in FIGS. 1, 2 and 3.

U.S. Pat. No. 6,969,286 issued to Mongold on Nov. 29, 2005 discloses another type of mechanism to attach the solder mass to the solder tail. According to Mongold, an electrical connector includes a connector body, a plurality of cores and a plurality of electrically conductive contacts disposed in the cores of the connector body. Each of the contacts includes a fusible member attached thereto. Each of the fusible members includes an intermediate portion and two support members disposed on opposite sides of the intermediate portion. The support members are arranged to hang down below a tail portion of the contacts. As illustrated in FIG. 1B, it looks like the solder mass 40a, 40b is attached to the contact terminal 22 in a manner of a landing gear of an airplane. According to Mongold, each fusible member 40 has two support portions 40a, 40b which are connected to each other by an intermediate portion 40c. The two support portions 40a, 40b are disposed opposite to each other and spaced from each other by a distance that is equal to a length of the intermediate portion 40c. The two support portions 40a, 40b may preferably have substantially flattened bottom surfaces as shown in FIG. 1B. However, the bottom surfaces of the support portions 40a, 40b may also have other shapes such as rounded, spherical, conical, square, rectangular, and other suitable shapes.

Chinese Utility Model Patent No. CN2618319Y published on May 26, 2004 discloses an arrangement in which both the contact and housing is used to hold the solder mass thereto. This arrangement is similar to what illustrated by Seidler, and Schnell, while the housing of the connector body is also used.

U.S. Pat. No. 6,572,397 issued to Ju on Jun. 3, 2003 discloses another arrangement in which the solder mass is held by a cuverlinear portion of a solder tail.

US Pat Pub. No. 20070293060 submitted by Ju discloses another arrangement in which a cradle-shaped portion is used to hold the solder mass.

Chinese Utility Model Patent No. CN2718822Y published on Aug. 17, 2005 discloses an arrangement in which two contact terminals are arranged within a single passageway and a solder ball is held by two solder tails of the contact terminals.

On the other hand, the use of gold on electrical contacts, specially on the solder portion is also well established in the electronic industry. Gold's high reliability under repeated use, its resistance to corrosion, and low contact resistance, makes it an outstanding material for coating electrical contacts, especially those used in low voltage devices. Gold is traditionally applied to electrical contacts by electroplating the gold from aqueous solutions of gold complexes, usually cyanides or chlorides. The electronics industry in response to escalating gold prices and ever increasing economic pressures has developed sophisticated equipment for continuous and selective plating of gold in spots and stripes on strips of metal components. There are, however, a number of problems associated with electroplating gold, such as contamination of the baths accompanied by the codeposition of undesirable materials on the contacts; restriction of the range of current usable to obtain optimum plating thus limiting the speed at which components may be plated; waste due to excessive coverage; and hazards associated with the use of such poisonous compounds as potassium cyanide. Concomitant with these are the associated problems of the disposal of the hazardous industrial waste.

Mechanic Ball Attachment (MBA) is a technology different what disclosed on U.S. Pat. No. 6,024,584 issued to Lekme on Feb. 15, 2000 along with its patent family discloses how to resist solder wicking along the contact by means of nickel layer or other mechanical measurements.

Ironically, Chinese Chinese Utility Model Patent No. CN2842814Y issued to Chen (Cheng '814 patent) on Nov. 29, 2005 discloses a technology by applying solder paste between solder ball and solder tail, see FIGS. 2, 3, 4, and 5. However, Chen does not detailedly disclose how those solder paste is applied. From the geometry of the contact, it is reasonably to conclude that the solder paste is applied after the contact terminals are assembled to the housing. There is some inconveniences when applying and deploying solder paste to the contact terminals after it is assembled onto passageways of a socket connector. In the above described Chen '814 patent, a lower portion of the contact terminal is almost located within the passageways, rending it is difficulty and inconvenient to apply the solder paste onto the lower portion located inside of the passageway. In addition, solder paste is sticky, and if additional or excessive solder paste leaks out from the lower portion, their sticky property may create lots of mess during handling and delivery. If the solder paste extends way up into a middle portion of the contact terminal, then it would be very much likely that the geometry of the contact terminal will be altered and negate proper and intended function of the contact terminals.

It is not uncommon to apply flux onto a solder pad of a contact terminal before a solder ball is attached thereto while in the above-described situation, it is unlikely to apply flux onto the intended area while without contaminating insulative housing as well as contact geometry.

### SUMMARY OF THE INVENTION

An object of the present invention is to provide a contact terminal in which a layer of a dried preparation of oxidation retarding and solder affinity deployed on the terminal portion such that when a solder ball is melted adjacent to the terminal portion, the molten solder can be evenly and homogeneously distributed along the terminal portion effectively prevent the molten solder flows toward a conductive pad of a printed circuit board.

In order to achieve an object set forth, a contact for an electrical connector mountable on a substrate made in accordance with the present invention comprises a medial portion; a contact engaging portion associated with the medial portion, said contact engaging portion being adapted to engage a conductive component; and a solder portion associated also with the medial portion. A substantially dried preparation of oxidation retarding and solder affinity is deployed on the terminal portion before the contact assembled into the connector.

According to one aspect of the present invention, a socket connector adapted to be mounted on a substrate having a conductive element is provided, and comprises an insulative housing, the housing having an exterior side adapted to face the substrate. A stamped contact is formed from a sheet of conductive material and is adapted to mate with a conductive component and extending substantially to the exterior side of the housing. The contact has a connection portion and wherein a substantially dried preparation of oxidation retarding and solder affinity deployed on the terminal portion before the contact assembled into the connector. The connector further includes a body of reflowable, electrically conductive material associated adjacent to the connection portion adjacent the exterior side of the housing.

### BRIEF DESCRIPTION OF THE DRAWINGS

FIG. 1 is a side elevational view of a carrier strip having stamped with at least one contact terminal thereon made in according to the present invention;

FIG. 2 is an illustractional view showing the contact terminal removed from the carrier strip of FIG. 1 is disposed into a passageway of a socket connector;

FIG. 3 is similar with FIG. 2, but taken from another side;

FIG. 4 shows another carrier strip stamped with at least another one contact terminal made in according to the present invention, wherein the contact terminal is suitable assembled onto another socket connector, such as that shown in FIG. 5; and

FIG. 6 is a flow diagram illustrating how a layer of preparation of oxidation-retarding and solder affinity material is deployed onto the solder portions of the contact terminals discussed above.

### DETAILED DESCRIPTION OF PREFERRED EMBODIMENT

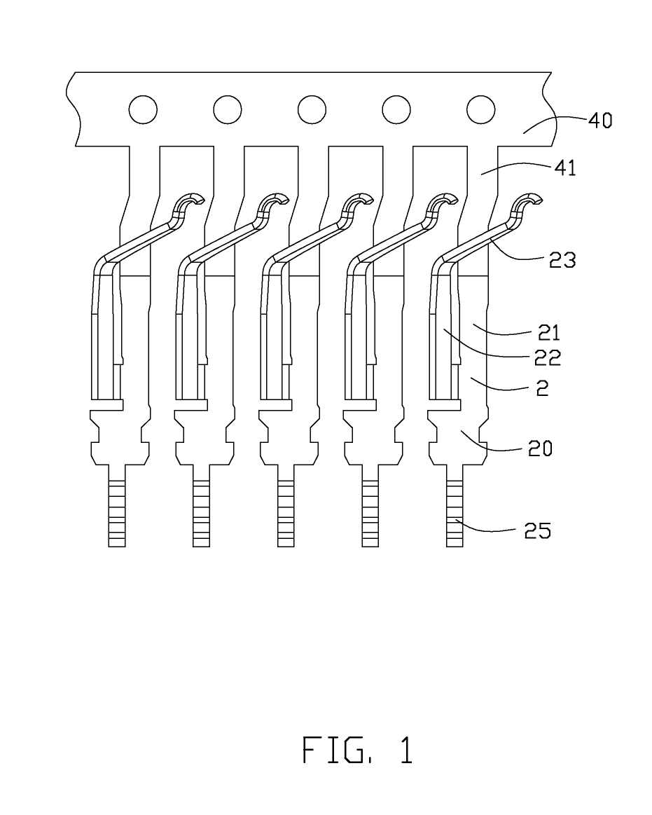

Referring to FIGS. 1-3 according to a first embodiment of present invention, a carrier strip formed from a sheet of conductive material is disclosed, and comprises a strip 40 and a plurality of contact terminals 2 connecting with the strip 40. The strip 40 has an edge formed with a plurality of interconnections 41, and the contact terminals 2 extend from the interconnections 41 of the trip 40. Each contact terminal 2 includes a base portion 21 with a medial portion 22 extending therefrom. A contact engaging portion 23 extends from the medial portion 22 which further includes a mating portion 24 for electrically contacting with a conductive pad of an IC package (not shown). The extension of the contact engaging portion 23 from the medial portion 22 gives a robust flexibility of the contact engaging portion 23 when it is in contact with the conductive pad of the IC package (not shown). The base portion 21 further includes a retaining portion 20. The contact terminal 2 further includes a solder portion 25 extending downwardly from the retaining portion 20 of the base portion 21.

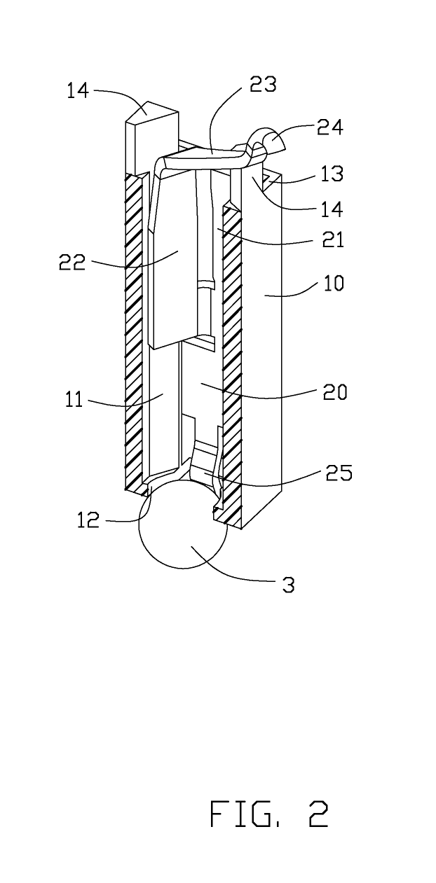

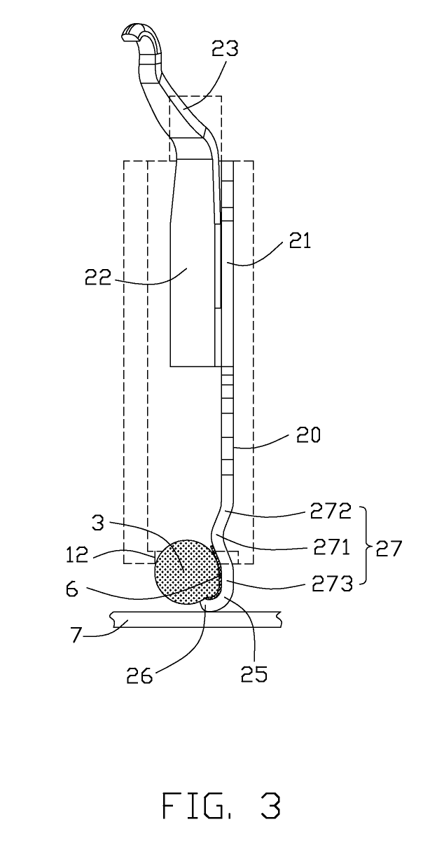

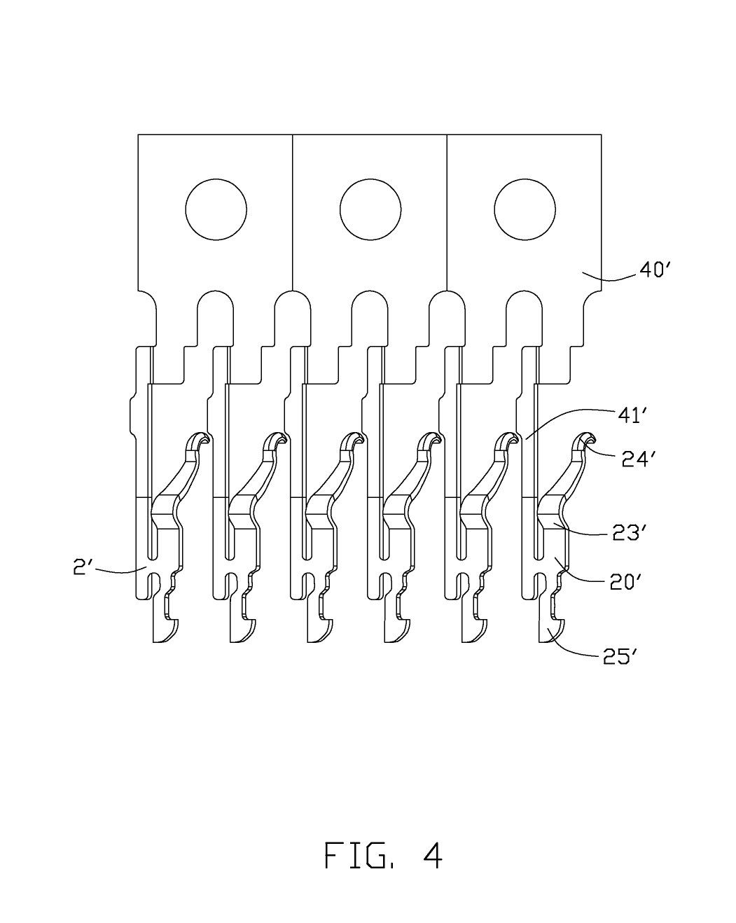

FIGS. 2-3 show a part of a socket which is adapted to be mounted on a substrate 7 having a conductive element (not shown). The socket comprises an insulative housing 10 defining an array of passageways 11 (only one is shown for simplicity) and having an exterior side adapted to face the substrate 7 and assembled therein with the stamped contact terminal 2, which is adapted to mate with a conductive component (not shown) and extending substantially to the exterior side of the insulative housing 10. Each of the contact terminals 2 is assembled in the corresponding passageway 11. A solder ball 3 is then snuggly secured between a bottom edge 12 of the passageway 11 and the solder portion 25. In this embodiment, the edge 12 is a curvilinear edge. As a result, the solder ball 3 is associated adjacent to the solder portion 25 adjacent the exterior side of the housing 10. The housing 10 further includes a top surface 13 with a pair of standoffs 14 associated with each of the passageway 11. The provision of the standoffs 14 will prevent the contact engaging portion 23 from collapsing in case of excessive work load is inadvertently exerted and deployed to the contact engaging portion 23.

Now specially draw to the attention of FIG. 3, the solder portion 25 includes a wave arrangement 27 and which includes a peak 271, a first slope 272 located above the peak 271 and a second slope 273 located below the peak 271. The waveform section 27 further includes a curvilinear lobe 26 at a free end thereof. Since the peak 271 projects toward the solder ball 3, accordingly, an edge of the solder ball 3 is substantially surrounded by the peak 271, the second slope 273, and the curvilinear lobe 26. By this arrangement, the surface contact area between the solder portion 25 and the solder ball 3 is preferably increased and which benefits a later surface mount process in which the socket connector is soldered onto the substrate 7.

In this embodiment, it can be readily appreciated that bottom edge 12 of the passageway 11 and the curvilinear lobe 26 properly cradle the solder ball 3 therebetween. In fact, the bottom edge 12 provides a horizontal support or limitation, while the curvilinear lobe 26 along with the peak 271 of the wave arrangement 27 provides a vertical support or limitation. Accordingly, the solder ball 3 is securely and robustly cradled between those two curvilinear supports, i.e. the bottom edge 12, and the curvilinear lobe 26.

Referring to FIG. 3 again, after the contact terminal 2 is stamped and before being assembled to the housing 10, an oxidation retarding and solder affinity liquid is deployed on the solder portion 25. The oxidation retarding and solder affinity is preferably a flux containing most part of isopropanol along with other ingredients. The oxidation retarding and solder affinity liquid is spayed to the pertinent area, and after it is dried, a dried preparation 6 thereof is formed on the solder portion 25. This process is performed while the contact terminal 2 is still disposed in the strip 40. The layer of the dried preparation 6 can clean and remove an oxidized layer on the solder portion 25 during the reflowing process. So when the solder ball 3 is melted during the reflowing process in a high temperature, the layer of dried preparation 6 will be active and cleans and removes the oxidation originally existed on the solder portion 25, then the molten solder 3 can be evenly and homogeneously distributed along the solder portion 25 effectively to prevent the molten solder 3 from largely flowing toward the conductive pad of the substrate 7.

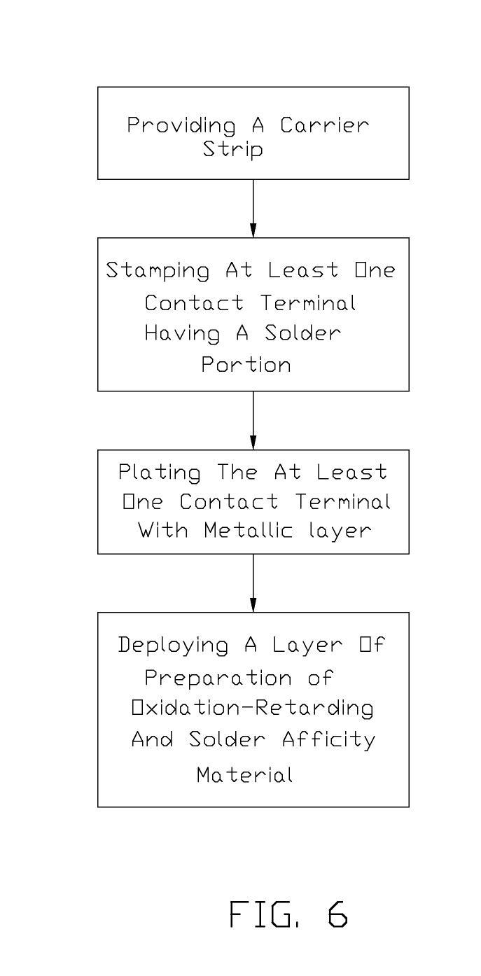

FIG. 6 shows a process for applying the dried preparation 6 of oxidation retarding, comprises the step of: 1) providing a carrier strip; 2) stamping at least one contact terminal in the carrier strip with at least a solder portion; 3) plating the contact terminals with base metals; and 4) deploying the solder portion with a liquid of oxidation retarding and solder affinity such that a layer of preparation is formed at the solder portion. And the base metal includes nickel and gold. The oxidation retarding and solder affinity liquid contains following materials with content in weight: isopropanol (>90%), resin (<5%), surfactant (<5%), anti-corrosive (<5%) and dispersant (<1%). Wherein, the resin can be chose from following group: gum rosin, wood rosin, ester of hydrogenated rosin, dehydrogenated rosin, and polymerized rosin. The surfactant can be chose from following group: perfluoroalkyl ethoxylate, cetyltrimethylammonium bromide and nonylphenoxypolyethoxyethanol. The anti-corrosive can be chose from following group: BHT (2,6-Di-tert-butyl-4-methylphenol purum), triphenyl phosphate, double-hydroquinone, 1,2,3-hydroxybenzotriazole, 2-Ethylhexyl glycidyl ether, tetrahydrofurfuryl alcohol and Palmitate. The dispersant can be chose from following group: nitroethane, dipropylene glycol methyl ether, diethylene glycol monobuthyl ether and polyglycol.

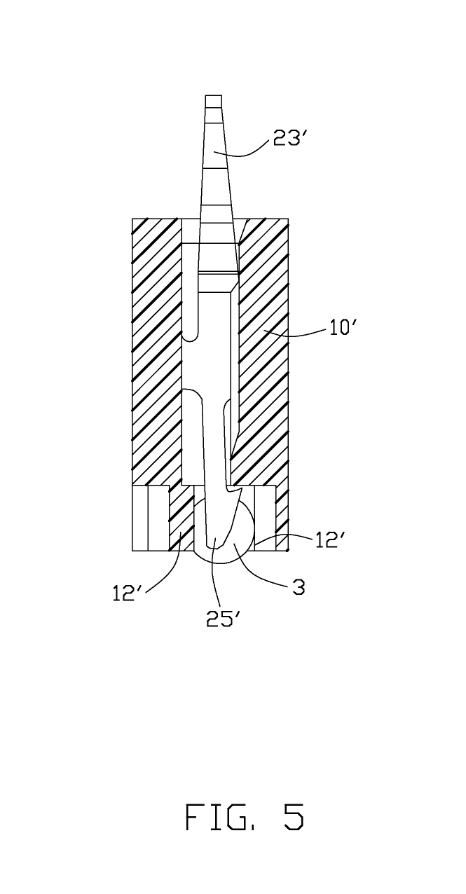

Referring to FIGS. 4-5 according to another embodiment of present invention, another type of contact terminal 2′ formed on a contact strip 40′ is disclosed, the contacts 2′ connecte with the contact strip 40′ by a plurality of interconnections 41′ and extending downwardly therefrom. The contact terminal 2′ includes a base 20′, a contact engaging portion 23 extending from the base 20′ with a mating portion 24′ for engaging with the IC package (not shown), and a mounting portion 25′ extending downwardly from the base 20′. The contact terminal 2′ is assembled to a housing 10′, which has a plurality of protrusions 12′ on an exterior bottom side thereof. The protrusions 12′ and the mounting portion 25′ cooperatively clamp the solder ball 3 to retain the solder ball 3.

Similar with the contact terminal 2 in the first embodiment, oxidation retarding and solder affinity is deployed on the mounting portion 25′ when the contact terminal 2′ is still connected with the interconnections 41′ before assembled to the housing 10′. The oxidation retarding and solder affinity liquid is spayed to the pertinent area, and after it is dried, a dried preparation (not shown) thereof is formed on the mounting portion 25′. So when the solder ball 3 is melted, the dried preparation (not shown) cleans the oxidation on the mounting portion 25′, then the molten solder 3 can be evenly and homogeneously distributed along the solder portion 25′ effectively to prevent the molten solder 3 from flowing toward the conductive pad of the substrate (not shown).

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. A contact terminal for an electrical connector mountable on a substrate, comprising:
a medial portion;
a contact engaging portion associated with the medial portion, said contact engaging portion being adapted to engage a conductive component;
a solder portion associated also with the medial portion; and
a substantially dried preparation of oxidation retarding and solder affinity deployed on the solder portion before the contact terminal assembled into the connector.

2. The contact terminal as recited in claim 1, wherein the solder portion further includes a waveform section having a peak.

3. The contact terminal as recited in claim 2, wherein the waveform section further includes a curvilinear lobe at a free end thereof.

4. The contact terminal as recited in claim 2, wherein a slope is defined below the peak of the waveform as viewed vertically.

5. The contact terminal as recited in claim 3, wherein the curvilinear lobe is coated with the preparation of solder affinity.

6. A socket connector adapted to be mounted on a substrate having a conductive element, comprising:
an insulative housing, the housing having an exterior side adapted to face the substrate;
a stamped contact terminal formed from a sheet of conductive material, adapted to mate with a conductive component and extending substantially to the exterior side of the housing, the contact terminal having a solder portion, wherein a substantially dried preparation of oxidation retarding and solder affinity deployed on an exterior surface of the solder portion before the contact being assembled into the connector; and
a body of reflowable, electrically conductive material associated adjacent to the solder portion adjacent the exterior side of the housing.

7. The socket connector as recited in claim 6, wherein the body of reflowable, electrically conductive material is essentially discrete from the solder portion while mechanically in a pressing manner before the body of reflowable electrically conductive material is fused unto the solder portion in an integral manner.

8. A process for applying preparation of oxidation retarding, comprising the step of:
1) providing a carrier strip;
2) stamping at least one contact terminal in the carrier strip with at least a solder portion;
3) plating the contact terminals with base metals; and
4) dipping the solder portion with a liquid of oxidation retarding and solder affinity such that a layer of preparation is formed at the solder portion.

9. The process as recited in claim 8, wherein the base metal includes nickel.

10. The process as recited in claim 8, wherein the base metal includes gold upon nickel.

11. The process as recited in claim 8, wherein the oxidation retarding and solder affinity liquid contains isopropanol (>90%), resin (<5%), surfactants (<5%), anti-corrosive (<5%) and dispersant (<1%).

12. The process as recited in claim 8, wherein the resin can be chosen from following group: gum rosin, wood rosin, ester of hydrogenated rosin, dehydrogenated rosin, and polymerized rosin, the surfactant can be chose from following group: nonylphenoxypolyethoxyethanol, cetyltrimethylammonium bromide, and perfluoroalkyl ethoxylate, the anti-corrosive can be chose from following group: BHT (2,6-Di-tert-butyl-4-methylphenol purum), triphenyl phosphate, double-hydroquinone, 1,2,3-hydroxybenzotriazole, 2-Ethylhexyl glycidyl ether, tetrahydrofurfuryl alcohol and Palmitate, the dispersant can be chose from following group: nitroethane, dipropylene glycol methyl ether, diethylene glycol monobuthyl ether and polyglycol.
